(19) United States
(12) Patent Application Publication
(10) Pub. No.: US 2012/0156664 A1
(43) Pub. Date: Jun. 21, 2012

(54) SYSTEM AND METHOD FOR EVALUATING A LEVEL OF KNOWLEDGE OF A HEALTHCARE INDIVIDUAL

(76) Inventors: Peter HURWITZ, New York, NY (US); John Lapolla, New York, NY (US)

(21) Appl. No.: 12/968,455

(22) Filed: Dec. 15, 2010

(51) Int. Cl. G09B 23/28

(52) U.S. Cl. 434/262

(57) ABSTRACT

The invention relates to a system and method for evaluating a level of knowledge of a healthcare individual by providing a computer; software executing on the computer for prompting a healthcare individual to answer a first question from a first plurality of questions related to diagnosis or treatment of a health related ailment; software executing on the computer for automatically determining a degree of correctness of an answer to the first question by comparing the answer to a reference; software for automatically selecting a second question from a second plurality of questions based upon the degree of correctness; software for automatically generating a score based upon the degree of correctness; and, based upon a cumulation of scores, software for automatically determining whether or not the healthcare individual is permitted to progress to a next level for diagnosis or treatment based upon the score.

### CROSS REFERENCE TO RELATED APPLICATIONS

This application claims priority to U.S. Provisional Patent Application No. 61/266,055 filed on Dec. 2, 2009. The contents of the above-identified Application is relied upon and incorporated herein by reference in its entirety.

### RESERVATION OF COPYRIGHT

A portion of the disclosure of this patent document contains material to which a claim of copyright protection is made. The copyright owner has no objection to the facsimile reproduction by anyone of the patent document or the patent disclosure as it appears in the Patent and Trademark Office patent file or records, but reserves all other rights whatsoever.

### FIELD OF INVENTION

The invention relates to a system and method of automatically determining a level of knowledge of a healthcare individual and, depending upon the determined level, providing learning tools to the healthcare individual.

### BACKGROUND OF INVENTION

The healthcare industry typically suffers from information flow and workflow fragmentation. Traditionally, information was usually exchanged among various parties involved in healthcare, such as physicians, hospitals, insurers, students, medical staff, laboratories, employers, and others, using paper-based methods. As is well know in the art, such methods are often labor-intensive, inefficient, and error prone. Thus, some efforts were undertaken to improve the healthcare industry through the use of electronic information networks integrating healthcare participants.

However, electronic information may introduce other difficulties, such as implementation of an electronic information network that is reliable and consistent with traditional medical practices. Another difficulty is ensuring such electronic information is helpful to each healthcare individual (“HCI”), especially when one HCI may have a level of knowledge that is different from a next HCI.

In traditional information exchange prior to implementation of electronic information networks, there was often more human interaction on a personal or individual basis, wherein the human interactions would reveal a level of knowledge among various HCIs so that information exchanged thereafter would correspond to the level of knowledge of each HCI.

With the advent of electronic information, there is typically less human interaction and, as a result, this may cause less individualized attention or information that is the same or similar and that do not take into account varying levels of knowledge among the HCIs. This problem may be exacerbated when the information is for diagnosis, treatment, education, training, and the like, wherein providing information without accounting for varying levels of knowledge can negatively affect patients.

What is desired, therefore, is an invention that identifies gaps in knowledge. Another desire is a system and method that identifies gaps in performance behaviors. A further desire is a system and method of determining whether or not a healthcare individual is competent to perform a particular service. Yet another desire is a system and method that automatically poses questions to the healthcare individual to determine the competency and, based upon answers to said questions, automatically assigning a score to the healthcare individual. Still another desire is a system and method that, based upon the score, automatically permits the individual to progress to a next level of information or provides learning tools to the healthcare individual. Another desire is a system and method that measures each answer against findings from an expert panel and, to the extent that their answers fall short of standards and best practices, the healthcare individual will receive educational activities until such time as they can demonstrate an advance in knowledge.

### SUMMARY OF INVENTION

It is therefore an object of the invention to provide a system for evaluating a level of knowledge of a healthcare individual.

Another object is to provide a system that identifies gaps in knowledge of a HCI.

A further object is a system that automatically determines the level of competency of a HCI by determining a degree of correctness or score to each answer or, depending upon the area of health, each group of questions provided by the HCI.

Another object is a system that, based upon the degree of correctness or score, automatically determines whether or not the HCI is competent enough to progress to a next level of questions, diagnosis, or treatment.

Yet another object is a system that, in the event the degree of correctness or score is not sufficient, automatically sends learning tools or education to the HCI.

These and other objects are achieved by providing a computer; software executing on the computer for prompting a healthcare individual to answer a first question from a first plurality of questions related to diagnosis or treatment of a health related ailment; software executing on the computer for automatically determining a degree of correctness of an answer to the first question by comparing the answer to a reference; software for automatically selecting a second question from a second plurality of questions based upon the degree of correctness; software for automatically generating a score based upon the degree of correctness; and, based upon a cumulation of scores, software for automatically determining whether or not the healthcare individual is permitted to progress to a next level for diagnosis or treatment based upon the score.

In some embodiments, the system further includes software for providing a first question related to diagnosis or treatment of a health related ailment, wherein the first question is for prompting the healthcare individual to answer. In another embodiment, software selects a reference from the group consisting a panel of experts, a medical journal, a medical profession, a medical association, and combinations thereof.

In another embodiment, the system includes software executing on the computer for automatically providing diagnosis or treatment information based upon the score.

In further embodiments, the system includes software for automatically providing education to the healthcare individual based upon the score.

In an optional embodiment, the system has software for randomizing the first and second plurality of questions from a database of questions related to diagnosis and treatment of various ailments.

In other embodiments, the system includes software executing on the computer for certifying the healthcare individual upon completion of the education.

In some embodiments, the system has software executing on the computer for using qualitative reasoning when determining the degree of correctness. In some of these embodiments, the system includes software executing on the computer for using quantitative reasoning when determining the degree of correctness.

In a further embodiment, the system includes software executing on the computer for extracting empirical data when determining the degree of correctness.

In another embodiment, based upon completion of the education, software certifies the healthcare individual.

In some embodiments, the system has software executing on the computer for extracting information from media for formulating said at least one question.

In another aspect of the invention, a method for evaluating a level of knowledge of a healthcare individual includes the steps of providing a computer; providing a first question related to diagnosis or treatment of a health related ailment, wherein the first question is for prompting the healthcare individual to answer; based upon a first answer to the first question from the healthcare individual, automatically determining a degree of correctness of the first answer; based upon the degree of correctness of the first answer, automatically generating a first score; based upon the degree of correctness of the first answer, automatically providing a next question related to diagnosis or treatment of the health related ailment; and based upon a cumulation of scores, automatically determining whether or not the healthcare individual is permitted to progress to a next level for diagnosis or treatment based upon the score.

In one embodiment, the method, based upon a cumulation of scores, automatically provides education to the healthcare individual.

In another embodiment, the method includes the step of using qualitative reasoning when determining the degree of correctness.

In an optional embodiment, the method extracts empirical data when determining the degree of correctness.

### BRIEF DESCRIPTION OF FIGURES

FIG. 1 depicts the system in accordance with the invention.

FIG. 2 more particularly depicts the user preferences shown in FIG. 1.

FIG. 3 more particularly depicts the baseline knowledge and scoring shown in FIG. 1.

FIG. 4 more particularly depicts the case study shown in FIG. 1.

FIG. 5 more particularly depicts alternatives to the case study shown in FIG. 1.

FIG. 6 depicts empirical data and search terms as applied to the system shown in FIG. 1.

FIG. 7 depicts the software for the system shown in FIG. 1.

FIG. 8 more particularly depicts the software for the scoring shown in FIG. 1.

FIG. 9 depicts a method of providing the system shown in FIG. 1.

### DETAILED DESCRIPTION OF DRAWINGS

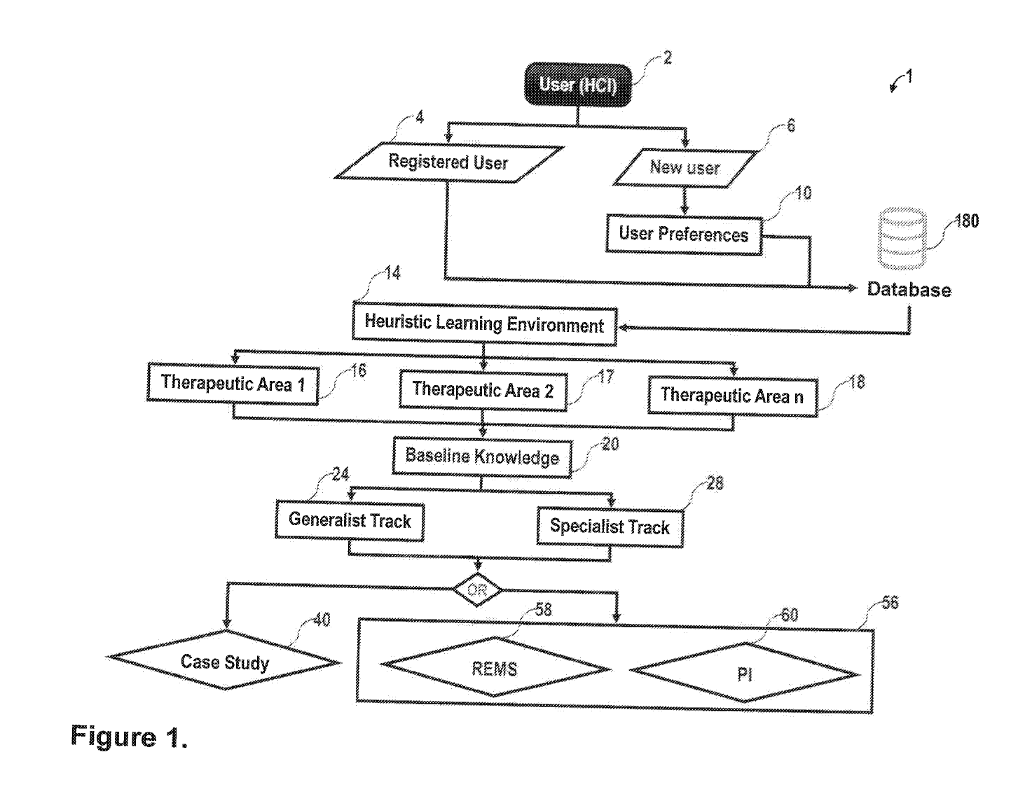

FIG. 1 depicts system 1 for evaluating a level of knowledge of a healthcare individual. System 1 provides user or healthcare individual (“HCI”) 2 with heuristic learning environment 14, wherein HCI 2 logs into a computer as registered user 4 or new user 6. If logging on as new user 6, HCI 2 needs to enter user preferences 10, which are saved in database 12 and are retrieved at a later login as registered user 4.

Once logged into system 1. HCI 2 is greeted with learning environment 14 and prompted to select a therapeutic area of from a selection of therapeutic areas 1-n. As shown, there are three therapeutic areas but any number n of areas may be presented, wherein HCI would select which one he/she wishes to enter. Therapeutic areas 1-n are a description of the medical field HCI wishes to enter. For example, skin disorders, cardiology, neurology, traumatic spinal injuries are all examples of therapeutic areas.

After entering the selected therapeutic area, baseline knowledge 20 is established, which entails a series of questions to establish a baseline of the HCI from which said HCI will be scored. Baseline questions will be related to the selected therapeutic area to get an understanding of knowledge HCI has in said area. This is different from information retrieved when HCI is a registered user 4 or information stored in user preferences 10.

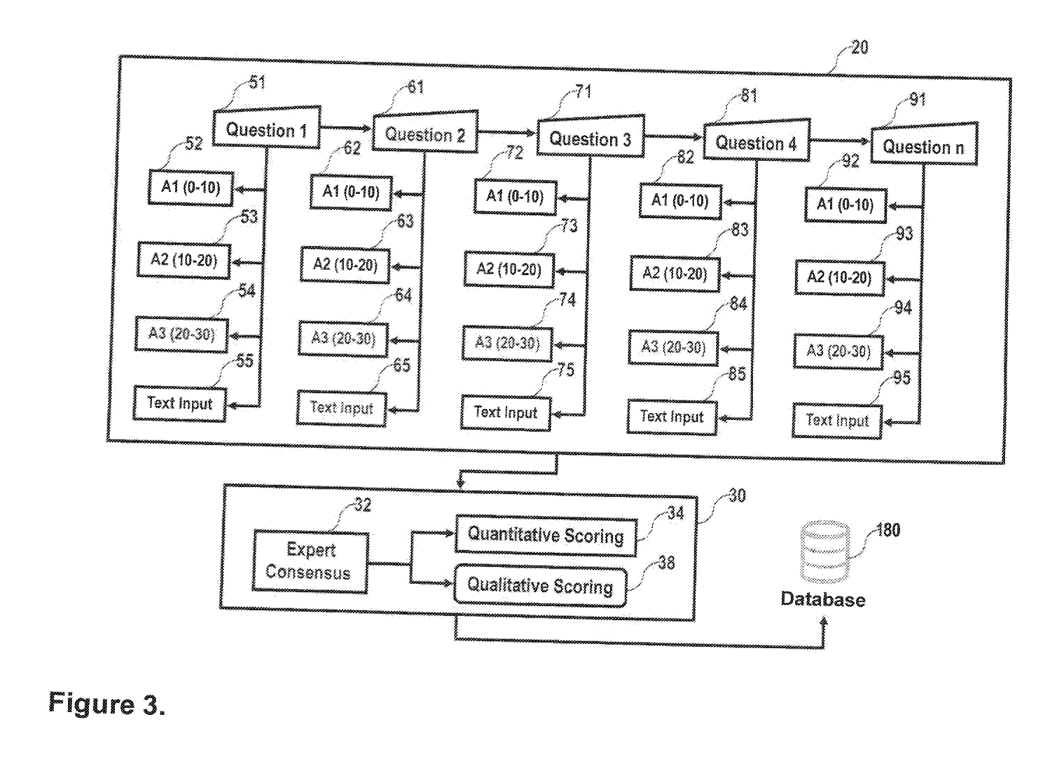

For example, a cardiologist seeking to understand spinal injuries more will have a different baseline than a spinal injury specialist. Baseline knowledge 20 ascertains this difference in knowledge via questions and answers and is more particularly described below under the description for FIG. 3.

After baseline knowledge 20 is established, HCI is determined to be a generalist in which case the HCI would be placed in generalist track 24 or HCI is determined to be a specialist in which case the HCI would be placed in specialist tract 28.

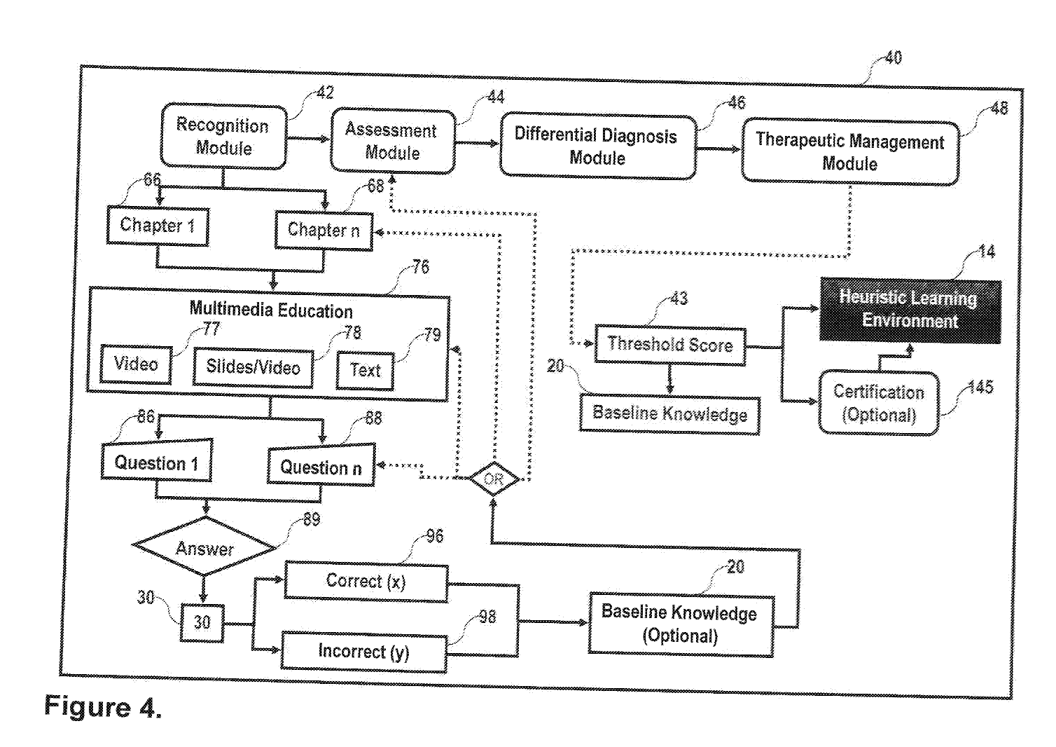

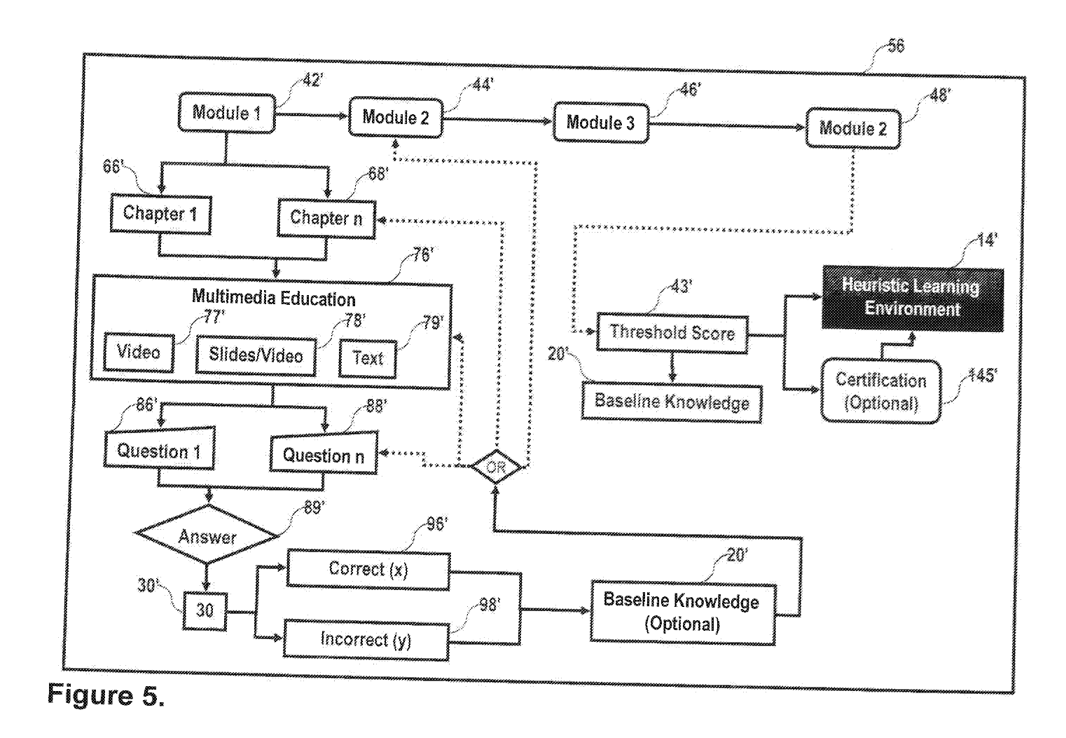

Subsequent to establishment of the foregoing, HCI would choose which a further area of study within the selected therapeutic area. For example, if the therapeutic area is cardiology, further areas of study may include open heart surgery, diseases of the heart, causes of a ruptured aorta, and the like. This further study is either case study 40 (see FIG. 4), Risk Evaluation and Mitigation Strategies (“REMS”) 58 (see FIG. 5), or Prescribing Information (“PI”) 60 (see FIG. 5).

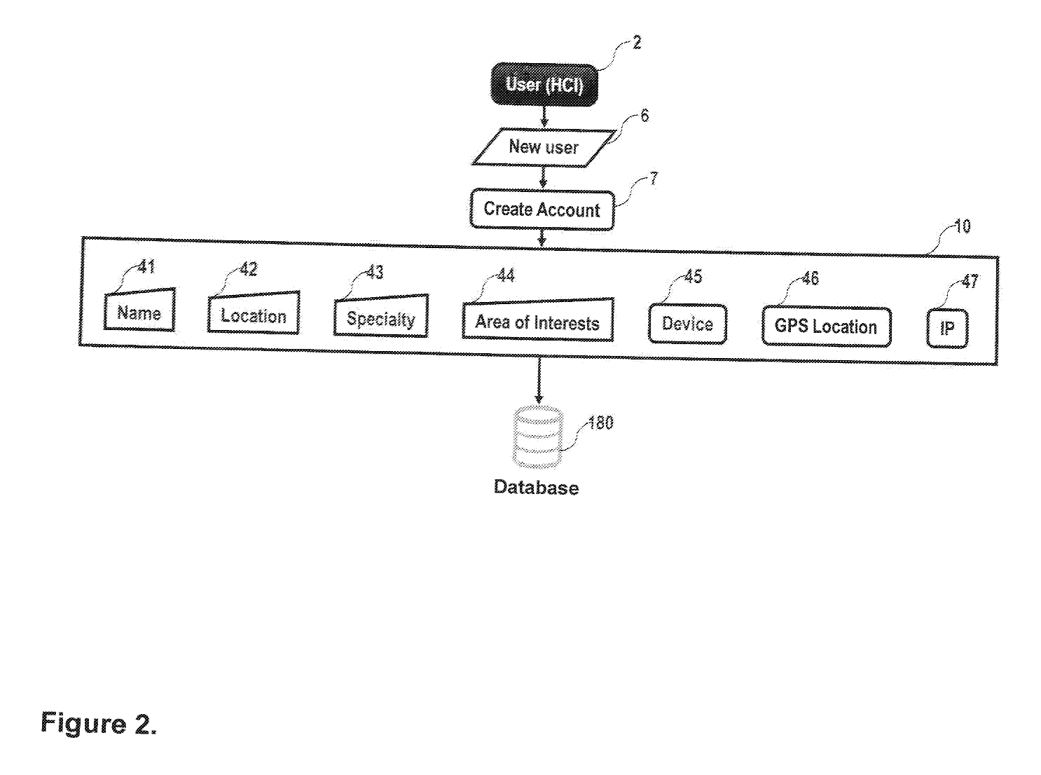

As shown in FIG. 2, user preferences is more particularly depicted, wherein information of HCI are submitted to database 180 after logging on. Examples of the HCI information submitted include name 41, location or address 42, specialty 43 such as cardiologist, area of interests 44 such as surgery, and the type of device from which HCI will submit answers or receive questions from system 1, including a mobile device 45. GPS location 46, internet provider 47, and the like.

FIG. 3 more particularly depicts baseline knowledge 20 in accordance with the invention. As shown, baseline knowledge or baseline questions 20 include a series of questions 1-n and multiple choice answers to each question A1, A2, A3 along with the ability for HCI to enter text to supplement an answer.

The purpose of baseline knowledge 10 is for establishing a starting point for HCI from which he/she will be measured. Different HCIs have different starting points because they have varying levels of knowledge. Otherwise, it would be unfair to score or assess the degree of correctness for all HCIs from a single starting point, where doing so may lead to inaccurate scores.

Also shown in FIG. 3 is software 30 for scoring an answer or determining a degree of correctness of an answer. This software is used in at least two locations in system 1, after baseline knowledge 10 and after answers are given by HCI within case study 40.

As shown in FIG. 3, answers to baseline questions 10 are compared with expert panel 32, quantitative scoring 34, and qualitative scoring 38. Software 30 for scoring is needed such that an initial assessment may be made of the HCI so that a baseline may be established.

FIG. 4 depicts case study 40 in greater detail. After baseline knowledge 10 is established. HCI is given a plurality of further areas of study, where case study 40 is one of these further areas of study. Case study 40 includes recognition module 42, assessment module 44, differential diagnosis module 46, and therapeutic management module 48. HCI selects which module to receive information. For example, if HCI wishes to receive diagnosis information, he/she would select differential diagnosis module 46.

Once selected, system 1 would begin with a first chapter 66 with diagnosis information (following example above) followed by multimedia 76, which may be video 77, slides 78, and/or text 79. Upon the conclusion of the multimedia and first chapter, a first question 86 is presented. HCI must provide answer 89 to first question 86. Upon receipt of answer 89, software 30 for scoring answer 89 determines a degree of correctness of answer 89 and assigns a score to answer 89.

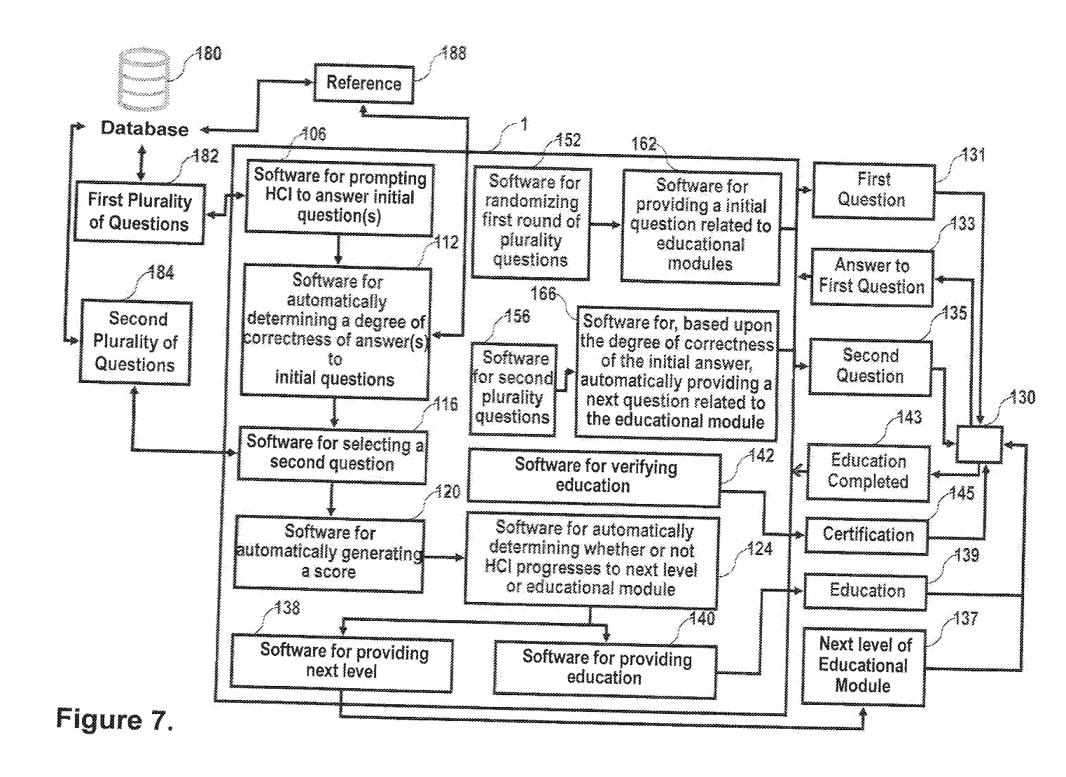

In some embodiments, several questions need to be answered, in which case questions 1-n are presented and each are answered before software 30 scores the answers and determines a degree of correctness. The software for scoring and determining the degree of correctness is more particularly described in FIG. 7.

In an optional embodiment, after the degree of correctness, as well as determining if correct 96 or incorrect 98, has been determined, it becomes part of baseline knowledge 20 for the particular HCI.

In other embodiments, once the degree of correctness has been determined, and assuming the HCI scores above the required threshold for the answer or answers, the HCI progresses to the next level, in this case chapter two and followed by multimedia and additional questions. This cycle continues until HCI completes all chapters or until HCI demonstrates he/she scores below the required threshold, in which case HCI is sent education.

In one embodiment, HCI needs to finish continuing education requirements. In this case, after successfully progressing through all levels, a certification 145 is given certifying completion.

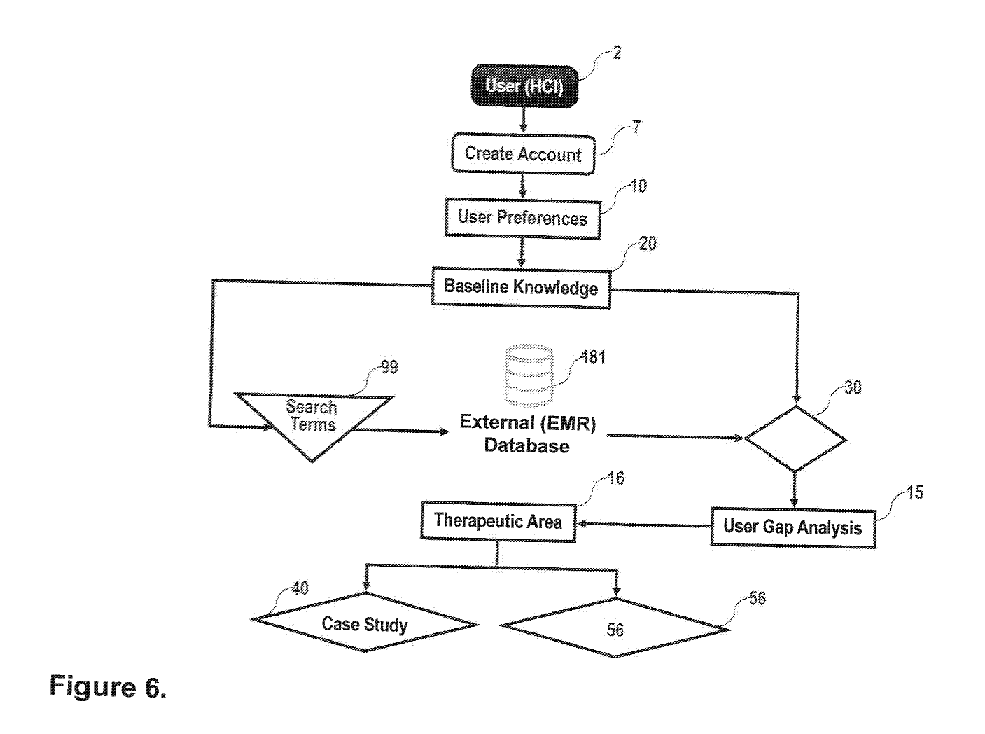

In an embodiment for REMS or PI, collectively shown in FIG. 5 as reference 56, the same procedure is followed as case study 40 in FIG. 4. FIG. 6 depicts external database 181 to which HCI uploaded empirical data, such as work HCI (assuming for this example HCI is a physician) performed in the field like hospital charts, dosing information to patients, recovery time for patients in view of HCI's care, and other data typically found from working as a physician.

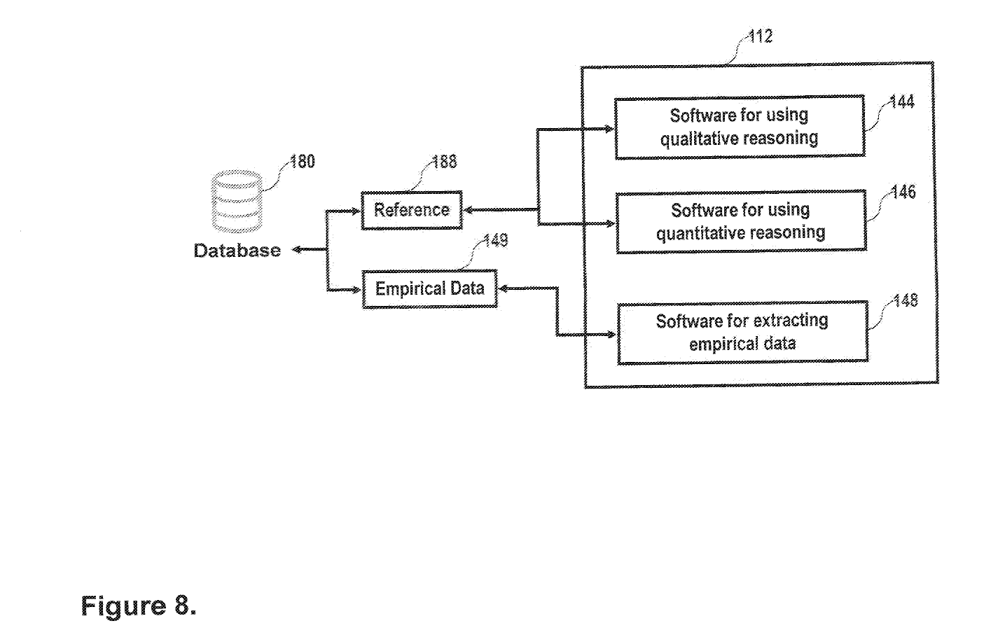

In some embodiments, baseline knowledge 20 is based upon the empirical data in addition to the above mentioned questions and answers during baseline questions. Differences between HCI's empirical data and suggestions from an expert panel stored on database 181 assist in determining a baseline for HCI. This difference or gap 15 is then stored and made a part of baseline knowledge 10. Further use of empirical data is further discussed below under FIG. 8.

As shown in FIG. 7, system 1 includes providing 130 a computer, software 106 executing on said computer for prompting a healthcare individual to answer a first question from a first plurality of questions related to diagnosis or treatment of a health related ailment, software 112 executing on said computer for automatically determining a degree of correctness of an answer to said first question by comparing the answer to a reference, software 116 executing on said computer for automatically selecting a second question from a second plurality of questions based upon the degree of correctness, software 120 executing on said computer for automatically generating a score based upon the degree of correctness, and software 124 executing on said computer for, based upon a cumulation of scores, automatically determining whether or not the healthcare individual is permitted to progress to a next level for diagnosis or treatment based upon the score.

In some embodiments, reference 188 is selected from the group consisting a panel of experts, a medical journal, a medical profession, a medical association, and combinations thereof. In a further embodiment, reference 188 is any standard accepted by medical professions in the field, any standard accepted by academics, and combinations thereof.

Database 180 stores reference 188, first plurality 182 of questions, and second plurality 184 of questions.

Software 112 for automatically determining a degree of correctness of an answer does so after each answer is given. Unlike traditional tests or questioning, which may have assessed performance of a HCI after completing of all questions and answers, software 112 determines correctness after every question.

In some cases, software 112 does so in real time, which means software 116 for automatically selecting a second question bases its selection upon the degree of correctness determined immediately prior to software 116 automatically selecting the second question and after software 106 prompts HCI to answer the question. In this manner, software 112 determines the degree of correctness immediately and in real time so that the second question is appropriate for the level of knowledge of HCI 2.

As shown, software 112 determines the degree of correctness by comparing the answer with reference 188. In some embodiments, software 112 does not merely compare an answer from HCI with reference 188 and determines it is correct or incorrect, but instead determines to what degree the answer is correct or incorrect. In other words, software 112 determines how far off HCI's answer is to reference 188.

For example, if the question is directed to proper treatment of pain in the ears, and there are multiple answers such as applying a cold pack, taking medication, or taking a look into the ear canal for signs of an ear infection, software 112 may determine the last choice would be given a higher degree of correctness or is more correct than the second choice, which is also correct but to a lesser extent of correctness as the last choice. The first choice would indicate an incorrect answer or a least correct answer among the three choices. Scoring the HCI would likewise vary in corresponding fashion where the second choice would be scored higher than the first choice and the third choice would be scored higher than the second choice.

In another embodiment, software 112 makes this determination after several answers instead of after each answer, depending upon therapeutic area 16-18, reference 188, and other factors that may require answers to several questions in order to assess a degree of correctness.

For example, if the therapeutic area of Alzheimer is complex and often difficult to diagnose properly, several questions directed to behavior over time may be required, according to an expert panel or reference 188. In this case, several answers are needed before a degree of correctness may be assessed for a HCI.

In another example, if the therapeutic area is skin lesions, the injuries are easily seen and thus a degree of correctness and score may be generated after a single question.

Hence, the number of questions and answers needed before a degree of correctness is determined depends upon the therapeutic area, expert panel, reference 188, and generally the science involved, such as its complexity and the general knowledge among those in the field of the chosen therapeutic area.

In some embodiments, and as shown in FIG. 8, software 112 for automatically determining a degree of correctness includes software 144 for using qualitative reasoning when determining the degree of correctness. Qualitative reasoning and its effect on determining correctness is more particularly defined below.

In another embodiment, software 112 for automatically determining a degree of correctness further includes software 146 for using quantitative reasoning when determining the degree of correctness. Quantitative reasoning and its effect on determining correctness is more particularly defined below.

In a further embodiment, software 112 for automatically determining a degree of correctness also includes software 148 for extracting empirical data 149 from database 180 when determining the degree of correctness.

Empirical data 149 is data loaded onto database 180 by HCI, typically during user preferences 10 or baseline questioning 20, which relates to the HCI's practices in the field, such as past diagnosis, dosing, treatment, and the like. For example, if HCI is a hospital physician, past medical charts are loaded to database 180, where the medical charts may relate to previous notes, prescriptions, treatment, and patient's length of stay and response to the prescriptions and treatments.

In some embodiments, in addition to the answers given by HCI, empirical data 149 is reviewed by software 112 for determining the degree of correctness. Hence, qualitative and/or quantitative reasoning are applied by software 112 not just to the answers to questions, but also to empirical data.

Subsequent to determining a degree of correctness, software 120 for automatically generating a score provides a score for each answer or, in the event several answers are needed before an assessment is made, provides a score for several answers.

Once a score is determined, software 124 for automatically determining whether or not HCI progresses to a next level either permits HCI access to the next level or sends education 139 to HCI.

If the score meets a threshold amount, system 1 includes software 138 for automatically providing the next level of diagnosis or treatment information based upon the score.

In some cases, next level 137 includes a next question or next set of questions. In other cases, next level 137 includes diagnosis or treatment information.

The threshold amount is stored in database 180 and is predetermined and dependent upon therapeutic area 16-18, reference 188, and combinations thereof.

In the event score does not meet threshold amount, system includes software 140 for automatically providing education to the healthcare individual based upon the score. In some embodiments, software 140 automatically provides education based upon a cumulation of scores, such as the end of questioning or when enough scores from individual answers are tabulated and a conclusion is drawn, when compared to reference 188, that the HCI needs learning.

Education 139 is sent because HCI demonstrated a level of knowledge that is below reference 188. Therefore, education 139 is sent to HCI to assist in raising the level of knowledge. Education 139 is sent in the form of audio, text, video, and combinations thereof.

In another embodiment, upon completion of education 139 or evidence that education was completed 143, such as a final written document, system 1 includes software 142 for certifying the HCI. In some of these embodiments, certification 145 is a document very much a continuation education credit or other certificate issued by an accredited university or academic institution.

The certification process for non-accredited programs may include the programs such as a class-wide opioid Risk Evaluation and Mitigation Strategy (REMS) supported by a Pharmaceutical or other Healthcare-related Company. This certification process would include necessary requirements to satisfy the funding Company and/or FDA requirements and be intended for prescribers, pharmacists and other HCIs.

In order to meet the requirements of the restrictive post-marketing control system under the new FDA Amendments Act authority, the FDA has suggested an opioid class REMS for the healthcare marketers and products in the long-acting and extended-release opioid category in order to prove competency and minimal demonstration of understanding of product or procedure risk. This opioid-class REMS will increase the level of safety and lower the risk associated with opioid drugs, with the hope of positively affecting patient outcomes.

The certification process will recognize those healthcare providers, through a registry, who have completed and/or successfully passed the necessary training, education, and who have received the minimal requirements needed, as directed by the FDA or sponsoring organization, in order to prescribe a medication or conduct a specific medical procedure.

Those healthcare providers that complete the necessary training and achieved a specified level of certification may be enrolled in a database or registry that could be monitored by the sponsoring or an outside auditing entity. Those healthcare providers that do not take part nor have completed a specified and required certification program may be limited in their prescribing authority or denied authority to perform certain medical procedures.

In view of the foregoing, the score generated after each question gives diagnosis or treatment information tailored to the individual HCI based on the HCI's level of knowledge. Similarly, the education given to the HCI is tailored to the individual HCI based on the HCIO's level of knowledge.

In an optional embodiment, system 1 includes software 152 executing on said computer for randomizing the first plurality of questions from a database of questions related to diagnosis and treatment of various ailments. This randomizing occurs before software 162 provides a first question to the HCI, wherein first question 131 is related to diagnosis or treatment of a health related ailment, wherein said first question is for prompting the healthcare individual to answer.

In some of these embodiments, system also includes software 156 executing on said computer for randomizing the second plurality of questions. This randomizing occurs before software 166 executing on said computer for, based upon the degree of correctness of the first answer 133, automatically providing a next question to the HCI, wherein next question 135 is related to diagnosis or treatment of the health related ailment. Randomizing makes the types of questions posed less predictable and harder for a HCI to memorize or anticipate a correct answer.

In a further embodiment, the first question is formulated by software that automatically extracts information from media, such as news, academics, and journals. In these embodiments, in addition to empirical data 149, software would automatically read and extract, based on key word searching, relevant information that is publicly available, such as treatises, news, articles, dissertations, and the like.

In some of these embodiments, system 1 also includes software for extracting information from media for determining the degree of correctness of the answer. In these embodiments, very much like empirical data 149 is used for determining the degree of correctness, software 112 uses the extracted information above in determining the degree of correctness.

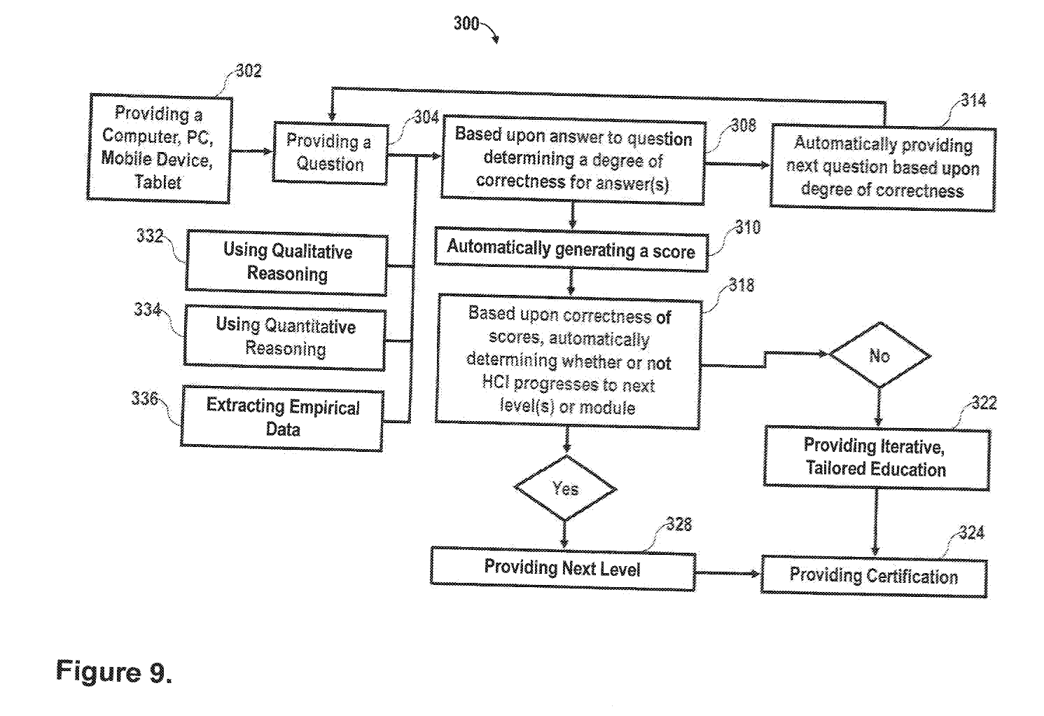

In one aspect of the invention, and as shown in FIG. 9, method 300 is provided for evaluating a level of knowledge of a healthcare individual, including the steps of providing 302 a computer; providing 304 a first question related to diagnosis or treatment of a health related ailment, wherein said first question is for prompting the healthcare individual to answer; and, based upon a first answer to said first question from the healthcare individual, automatically determining 308 a degree of correctness of the first answer.

Method 300 also includes, based upon the degree of correctness of the first answer, automatically generating 310 a first score and, based upon the degree of correctness of the first answer, automatically providing 314 a next question related to diagnosis or treatment of the health related ailment. Method 300 also provides, based upon a cumulation of scores, automatically determining 318 whether or not the healthcare individual is permitted to progress to a next level for diagnosis or treatment based upon the score.

If method 300 determines the HCI is permitted to progress to a next level, method 300 includes the step of providing 328 a next level. If method 300 determines the HCI is not permitted to progress to a next level, method 300 includes the step of automatically providing 322 education and, upon completion of the education, providing 324 certification.

In some embodiments, method 300 includes using 322 qualitative reasoning when determining the degree of correctness. In other embodiments, method 300 includes using 324 quantitative reasoning when determining the degree of correctness. In a further embodiment, method 300 includes extracting 326 empirical data when determining the degree of correctness.

The following describes the purpose and operation of the invention in greater detail along with examples of the invention.

Once the healthcare individual (HCI), which may be a practitioner, has registered with a user name and password and logged in with a self-identified specialty, the user may select from a series of educational offerings. Each activity is developed to reflect core competencies for generalists and specialists alike, as determined by an expert panel. The user experience is seamless, providing in real time multimedia education based on quantitative and qualitative assessment of the end user's responses.

Fundamental to the proposed invention is a scoring system that automatically evaluates HCI knowledge, practice behaviors, attitudes, and biases. Since much of medicine today is predicated on subjective interpretation of available evidence and, when the evidence is lacking, on clinical experience, the scoring system helps bridge the inevitable gaps in HCI practices with expert consensus. More precisely, the scoring system reflects expert empirical observations and interpretation of the strengths and limitations of current evidence-based guidelines. The invention utilizes questionnaires formulated by an expert panel of HCIs, educators, and statisticians that, on a question by question basis, reveal end user deficits in knowledge and evidence-based best practices.

The granularity and level of rigor of each question can be tailored to the end user's specialty, subspecialty, and patient population. Further, the questionnaire constitutes an elaborate decision tree: the end user's response to each question begets a multimedia presentation—in text, audio, and/or video streaming—explicating the merits or weaknesses of the selection, as defined by the expert panel. If the end user should fail to answer a question correctly, the logic of the code permits the seamless, real-time selection of follow-on educational activities until the end user is capable of answering similar questions correctly, demonstrating comprehension and core competency in particular subject matter(s). The questionnaire is embedded in the code and the educational activities are selected as a function of each respondent's score.

As discussed herein, the invention reflects current needs for education that marries evidence based practice with practice based evidence—ie, education that targets the inherently ambiguous junction where evidence from well designed studies ends and clinical judgment begins. Here, clinicians necessarily apply the evidence insofar as possible and exercise their discretion, relying on experience and guidance from local, regional, and national thought leaders (See below for select examples).

Notably, evidence based recommendations are predicated on studies of populations with rigorous inclusion and exclusion criteria; therefore, these and related practice parameters are thought to be necessary but not sufficient, creating conceptual framework within which clinicians must apply their training so as to tailor the evidence to individual patients, most of whom present with confounding factors unaddressed by clinical trials of relatively homogeneous patient populations. Accordingly, this invention embodies an expert-based scoring system—with a logic and code on the backend—that achieves two critical objectives.

First, the invention critically evaluates measurable discrepancies between HCI judgment and expert consensus, the latter directly addressing gray areas in the evidence base that supports to varying degrees diagnostic and therapeutic decisions. Second, the invention tailors the delivery of multi-media educational programs to narrow the observed educational and performance gaps until competency is achieved. And once achieved, end users may progress to subsequent learning modules. Below are comprehensive reviews of two discrete though related disease states, each illustrating the nuances of individualized care and the distinct value of a digital educational environment that—through iterative trial-and-error decision making—can facilitate advances in knowledge and evidence based clinical decision making.

### Examples of Quantitative and Qualitative Assessment of HCI Competency

### Diabetes

Type 2 diabetes mellitus (T2DM) is a progressive disease marked by chronic insulin resistance and inflammation, which drive disturbances in glucose and lipid metabolism as well as dysfunction and eventual loss of pancreatic β-cells. Metabolic abnormalities observed before the onset of frank diabetes are thought to dampen the insulin sensitivity of skeletal muscle, contributing to insulin resistance and its sequelae. Central adiposity is a risk factor for the profound metabolic disturbances observed in this population. If not treated promptly and aggressively. T2DM progresses to cerebral, coronary, and peripheral vasculopathies and peripheral neuropathy. In their efforts to compensate for insulin resistance, pancreatic β-cells increase insulin secretion, leading to hyperinsulinemia and eventual β-cell failure, a hallmark development in patients with T2DM as well as T1DM.

In patients with T2DM, hyperglycemia triggers pathophysiologic processes such as such as vascular oxidative stress and inflammation, and increased platelet activity, which in turn lead to microvascular and macrovascular complications. Moreover, acute postprandial fluctuation in glucose levels is increasingly recognized as an important pathophysiologic mechanism alongside basal hyperglycemia. Indeed, studies demonstrate that postprandial glucose is a stronger predictor of macrovascular complications that fasting glucose. Absent timely diagnosis and aggressive treatment, diabetes adversely affects the retina, nervous system, and kidney, and is the leading cause of blindness and kidney failure in this country. Additionally, diabetes is causally related to such macrovascular complications as cardiovascular disease (CVD), stroke, and peripheral vascular disease.

Accumulating evidence indicates that optimal management is combinatorial, reflecting underlying multifactorial disease mechanisms. Specific combinations of pharmacologic and nonpharmacologic interventions are increasingly employed to achieve predefined treatment goals. Data shows that despite a decline in CVD events among adults with diabetes (attributed to advances in CV care), CVD events still occur twice as often in this population as in adults without diabetes. This finding indicates that trends in declining risk factors and advances in management of CV events in patients with diabetes require aggressive educational activities—as embodied in this invention—that are at once globally available and individualized to each learner's demonstrated needs, competencies, and learning style.

Upon diagnosis, tailoring therapy consistent with patient needs, goals, and comorbidities remains the threshold challenge in T2DM. It is noteworthy that guidelines issued jointly by the American Diabetes Association (ADA) and the European Association for the Study of Diabetes (EASD) differ significantly from those issued by the American Association of Clinical Endocrinologists (AACE) and the American College of Endocrinology (ACE). Such variability in evidence-based recommendations highlights the critical importance of clinical judgment and for the proposed invention. PCPs require an individualized, self-directed educational experience designed to improve their ability to formulate patient-specific treatment goals and rational multidrug regimens.

The seminal United Kingdom Prospective Diabetes Study demonstrated that surviving β-cells in patients with diabetes are ultimately unable to secrete insulin. In fact, by the time of T2DM diagnosis, independent studies suggest that up to 50% of β-cell mass has been lost. Critically, these and related β-cell deficits observed in insulin-resistant and diabetic patients are potentially reversible, particularly in the early stages of disease onset. Recognition and treatment of impaired carbohydrate and lipid metabolism in primary care patients is therefore critical to blunt the adverse effects of glucotoxicity and lipotoxicity on the remaining β-cells in T2DM as well as T1DM.

Of central importance to optimal diabetic care is identifying an appropriate level of glycosylated hemoglobin (A1C)—the preferred glycemic index, reflecting both fasting and postprandial glucose—and maintaining that level over time through long-term monitoring and therapeutic adjustments. Importantly, for every 1% drop in A1C there is a 40% reduction in risk of microvascular complications. (NIDDK) Recent estimates of the proportion of patients achieving the ADA A1C goal of <7.0% range from approximately 50% to 57%, and only 33.0% of patients achieve the more aggressive AACE A1C goal of <6.5%.

Similar results have been reported for goals related to blood pressure (BP<130/80 mm Hg; 45.5%), low-density lipoprotein cholesterol (LDL-C<100 mg/dL; 45.6%), and an aggregate of A1C level, BP, and LDL-C (12.2%). The clinical argument for achieving consensus target values in A1C has been complicated by results from four recent studies suggesting that tight glycemic control may not yield clinically meaningful reduction of cardiovascular outcomes and in select at-risk patients may even cause premature mortality. These data stand in contrast to results from two other studies, which showed no significant difference in mortality rates for A1C goals of ≦6.5% (ADVANCE*; 11,140 patients; mean duration of 8 years) or <6.0% (VADT*; 1791 patients; mean duration of 11.5 years) versus less intensive goals. Interestingly, the ADVANCE study demonstrated nephroprotective benefits for patients with near normal A1C values receiving intensive versus standard glycemic control.

Subset analyses of these three trials suggest that there may in fact be a net cardiovascular benefit of intensive glycemic control in select patients. Specifically, select patients may benefit from even lower A1C goals than the general goal of <7% if this can be achieved without significant hypoglycemia or other treatment-related adverse effects. Such patients might include those with short duration of diabetes, long life expectancy, and no significant cardiovascular disease. Further, in patients with relatively recent onset diabetes and only modestly elevated A1C, the contribution of postprandial glucose fluctuations to the adverse consequences of hyperglycemia is stronger than the contribution of fasting glucose, indicating a need to restructure monitoring and treatment strategies accordingly.

Management of postprandial glucose fluctuations should be a key component of care along with control of fasting glucose.

Additional study results have yet to resolve some of the challenges in goal selection and patient selection. Less stringent A1C goals than the general goal of <7% have been suggested for distinct subpopulations. For example, clinicians necessarily establish realistic goals for special patient populations: those with a history of severe hypoglycemia, limited life expectancy, advanced microvascular or macrovascular complications, extensive comorbid conditions, or long-standing diabetes resistant to achieving more stringent goals despite multimodal diabetes therapies.

Lack of consensus on A1C goal setting is mirrored by the considerably diverse set of evidence-based practice behaviors. Most prominently, there are clear differences between the AACE/ACE and ADA/EASD algorithms for T2DM management. That significant differences exist reflects the limitations of available evidence that could otherwise provide answers to questions of fundamental importance: Which medications are required in newly diagnosed patients? Which treatments are critical add-ons for patients who prove only partially responsive? What is the role of insulin in newly diagnosed, treatment-naïve vs treatment-experienced patients?

Additional well-designed studies are clearly needed to resolve these issues and, in particular, to further evaluate the differential effects of glycemic control in subpopulations. Meanwhile, clinicians must rely on expert consensus and their own clinical judgment, again highlighting the distinct benefits of the invention.

The limited availability of conclusive evidence underscores the need for targeted, heuristic education that identified gaps in knowledge and performance and iteratively delivers multimedia education until the gaps are bridged and a level of competency—as established by qualitative and quantitative scoring—is achieved.

### Acute Coronary Syndrome

Acute coronary syndrome encompasses unstable angina (UA), non-ST-segment-elevation myocardial infarction (NSTEMI), and ST-segment-elevation myocardial infarction (STEMI). Despite significant advances in patient care, significant practice gaps still remain, all of which are associated with delays in diagnosis and suboptimal treatment. UA, NSTEMI, and STEMI share a common pathophysiology involving thrombus formation secondary to either plaque erosion or rupture.

Thus, therapy targeting platelet activation/aggregation has become the standard of care. All patients admitted with ACS receive aspirin, unless contraindicated. In contemporary practice, patients also receive a second antiplatelet agent, and the relative risks and benefits of the available agents for individual patient types are an intensive area of clinical research.

Activated platelets release adenosine diphosphate (ADP), which plays a crucial role in platelet aggregation. There are two ADP receptors: P2Y1 and P2Y12. Activation of P2Y1 results in only weak and transient platelet aggregation. In contrast, activation of P2Y12 is necessary for the full aggregation response to occur. P2Y12 effects include activation of the glycoprotein (GP) IIb/IIIa receptor, granule release, amplification of platelet aggregation, and stabilization of the platelet aggregate. Data from a number of clinical trials now support the combination of P2Y12 inhibitors with aspirin.

Beginning in 2007, studies were reported suggesting that loss-of-function polymorphism in genes modulating absorption (eg, ABCB1) and activation (eg, CYP2C19) of clopidogrel (an antiplatelet agent, thienopyridine, and P2Y12 antagonist) may be associated with increased risk of thrombotic events. In response to the emerging data, the FDA in 2009 added a boxed warning to clopidogrel's prescribing information and alerted clinicians to the availability of tests for the CYP2C19 loss-of-function allele.

However, more recently published data suggest that loss-of-function polymorphisms are only clinically relevant in clopidogrel-treated ACS patients who undergo stenting and that these polymorphisms were not associated with increased risk in clopidogrel-treated ACS patients treated medically.

Moreover, these polymorphisms are not associated with increased risk for cardiovascular events in patients treated with newer generation P2Y12 inhibitors. The clinical data and the FDA decisions have complicated the management of stabilized patients just prior to and following discharge from the hospital and underscore the need for education, particularly on the role of genetic polymorphism testing.

A related issue concerns the potential for a diminished antiplatelet effect resulting from interaction between P2Y12 inhibitors and drugs (such as proton pump inhibitors) that inhibit cytochrome P450 enzymes. In 2009, observational studies were reported suggesting that proton pump inhibitors may diminish the antiplatelet effect of clopidogrel. Again in response to these data, the FDA issued a public health warning on a possible interaction between clopidogrel and one specific proton pump inhibitor, omeprazole. More recently, one study was reported that supported the FDA decision while another provided contrasting data. Until this more conclusive evidence becomes available, physicians will need guidance on deciding whether or not to co-administer a P2Y12 inhibitor and a proton pump inhibitor.

Best practice strategies for administering P2Y12 inhibitors across heterogeneous patient populations with ACS require expert interpretative insights. Of particular importance to practicing cardiologists are benefit/risk profiles of currently available antiplatelet agents, longitudinal assessment and adjustment of treatment strategies based on patient response and individualizing therapeutic regimens accordingly. Current guidelines for antiplatelet therapy were primarily based on multicenter trials that—like all clinical studies with rigorous inclusion and exclusion criteria—employed a “one size fits all” dosing strategy. Emerging treatment paradigms assign utmost importance to tailored dosing.

Studies in PCI patients have, for example, linked high on-treatment platelet reactivity with increased risk for thrombotic events, supporting the hypothesis that platelet function tests can improve tailored dosing strategies and reduce cardiovascular risk. Several tests of platelet function are available, though agreement among these tests is poor. There is also debate over whether point-of-care testing of platelet function is needed if genotyping for CYP2C19 is carried out or if both types of testing should be conducted. Consequently, experts in cardiology medicine agree that the role of point-of-care platelet function testing is still evolving, although the pace of development varies widely.

Protocols for ensuring accurate dosing of anticoagulants and parenteral antiplatelet agents and for thienopyridine prescription at discharge have been included in the American College of Cardiology/American Heart Association (ACC/AHA) 2008 performance measures for adults with MI. However, studies demonstrate that many patients with ACS (approximately one-third to one-half) do not receive thienopyridine therapy according to the ACC/AHA guidelines. An analysis of clopidogrel prescriptions found that only 39% met FDA criteria. The reasons for this practice gap are likely to be complex, involving physician understanding of agreement with guidelines.

Accordingly, to address guideline-based performance gaps directly as illustrated here, the invention provides a digital, trial-and-error (heuristic) educational paradigm. As per the latest in adult learning principles, HCIs will register and select digital activities of interest, each offering an iterative, needs-based approach to learning. Each activity begins with a self-assessment of gaps according to the scoring system discussed previously. Clinical decision making never occurs in a vacuum. Variability in physician practice patterns, and the size, location, and type of hospital all shape the antiplatelet, anticoagulant, and other pharmacologic therapies employed during the acute phase of an ACS. Accordingly, the invention utilizes expert consensus—a synthesis of evidence-based practice and practice-based evidence—as a yardstick to measure HCI performance.

1. A system for evaluating a level of knowledge of a healthcare individual, comprising:
providing a computer;
software executing on said computer for prompting a healthcare individual to answer a first question from a first plurality of questions related to diagnosis or treatment of a health related ailment;
software executing on said computer for automatically determining a degree of correctness of an answer to said first question by comparing the answer to a reference;
software executing on said computer for automatically selecting a second question from a second plurality of questions based upon the degree of correctness;
software executing on said computer for automatically generating a score based upon the degree of correctness; and
software executing on said computer for, based upon a cumulation of scores, automatically determining whether or not the healthcare individual is permitted to progress to a next level for diagnosis or treatment based upon the score.

2. The system according to claim 1, further comprising software executing on said computer for selecting a reference selected from the group consisting a panel of experts, a medical journal, a medical profession, a medical association, and combinations thereof.

3. The system according to claim 1, further comprising software executing on said computer for automatically providing diagnosis or treatment information based upon the score.

4. The system according to claim 1, further comprising software executing on said computer for automatically providing education to the healthcare individual based upon the score

5. The system according to claim 1, further comprising software executing on said computer for randomizing said first and second plurality of questions from a database of questions related to diagnosis and treatment of various ailments.

6. The system according to claim 1, further comprising software executing on said computer for certifying the healthcare individual upon completion of the education.

7. The system according to claim 1, further comprising software executing on said computer for using qualitative reasoning when determining the degree of correctness.

8. The system according to claim 7, further comprising software executing on said computer for using quantitative reasoning when determining the degree of correctness.

9. The system according to claim 1, further comprising software executing on said computer for extracting empirical data when determining the degree of correctness.

10. The system according to claim 1, further comprising software for extracting information from media for formulating said at least one question.

11. A system for evaluating a level of knowledge of a healthcare individual, comprising:
providing a computer;
software executing on said computer for providing a first question related to diagnosis or treatment of a health related ailment, wherein said first question is for prompting the healthcare individual to answer;
software executing on said computer for, based upon a first answer to said first question from the healthcare individual, automatically determining a degree of correctness of the first answer;
software executing on said computer for, based upon the degree of correctness of the first answer, automatically generating a first score;
software executing on said computer for, based upon the degree of correctness of the first answer, automatically providing a next question related to diagnosis or treatment of the health related ailment; and
software executing on said computer for, based upon a cumulation of scores, automatically determining whether or not the healthcare individual is permitted to progress to a next level for diagnosis or treatment based upon the score.

12. The system according to claim 11, further comprising software executing on said computer for, based upon a cumulation of scores, automatically providing education to the healthcare individual.

13. The system according to claim 11, further comprising software executing on said computer for, based upon completion of the education, certifying the healthcare individual

14. The system according to claim 11, further comprising software executing on said computer for, based upon a degree of correctness of a first answer, automatically generating a score in real time.

15. The system according to claim 11, further comprising software executing on said computer for using qualitative reasoning when determining the degree of correctness.

16. The system according to claim 15, further comprising software executing on said computer for extracting empirical data when determining the degree of correctness.

17. A method for evaluating a level of knowledge of a healthcare individual, comprising the steps of:
providing a computer;
providing a first question related to diagnosis or treatment of a health related ailment, wherein said first question is for prompting the healthcare individual to answer;
based upon a first answer to said first question from the healthcare individual, automatically determining a degree of correctness of the first answer;
based upon the degree of correctness of the first answer, automatically generating a first score; and
based upon the degree of correctness of the first answer, automatically providing a next question related to diagnosis or treatment of the health related ailment; and
based upon a cumulation of scores, automatically determining whether or not the healthcare individual is permitted to progress to a next level for diagnosis or treatment based upon the score.

18. The method according to claim 17, further comprising the step of, based upon a cumulation of scores, automatically providing education to the healthcare individual.

19. The method according to claim 17, further comprising the step of using qualitative reasoning when determining the degree of correctness.

20. The method according to claim 17, further comprising the step of extracting empirical data when determining the degree of correctness.
